(19) United States
(12) Patent Application Publication
(10) Pub. No.: US 2024/0107435 A1
(43) Pub. Date: Mar. 28, 2024

(54) APPARATUS, METHODS, AND COMPUTER PROGRAMS

(71) Applicant: Nokia Technologies Oy, Espoo (FI)

(72) Inventors: Philippe GODIN, Massy (FR); Alessio CASATI, WEST MOLESEY (GB); Muhammad NASEER-UL-ISLAM, Munich (DE); Srinivas BANDI, Bangalore (IN); Halit Murat GÜRSU, Munich (DE)

(21) Appl. No.: 18/474,568

(22) Filed: Sep. 26, 2023

(30) Foreign Application Priority Data
Sep. 27, 2022 (GB) 2214077.6

(51) Int. Cl. H04W 48/16; H04W 60/04

(52) U.S. Cl. CPC H04W 48/16; H04W 60/04

(57) ABSTRACT

A method comprises receiving network slice information from a core network entity, the network slice information related to a network slice which is not supported in one or more cells of a first tracking area, but which is supported in one or more cells of a second tracking area. The method further comprises triggering a procedure at a user equipment to access said network slice based on said network slice information when said user equipment is in one or more cells of the first tracking area.

### CROSS-REFERENCE TO RELATED APPLICATIONS

This patent application claims the benefit of priority of United Kingdom Patent Application No. 2214077.6 filed Sep. 27, 2022, which is hereby incorporated by reference as if reproduced in its entirety.

### FIELD OF THE DISCLOSURE

The present disclosure relates to apparatus, methods, and computer programs for communication systems and in particular but not exclusively to apparatus, methods and computer programs relating to network slices.

### BACKGROUND

A communication system can be seen as a facility that enables communications between two or more communication devices, or provides communication devices access to a data network.

A communication system may be a wireless communication system. Examples of wireless communication systems comprise public land mobile networks (PLMN) operating based on radio access technology standards such as those provided by 3GPP (Third Generation Partnership Project) or ETSI (European Telecommunications Standards Institute), satellite communication systems and different wireless local networks, for example wireless local area networks (WLAN). Wireless communication systems operating based on a radio access technology can typically be divided into cells and are therefore often referred to as cellular systems.

A communication system and associated devices typically operate in accordance with one or more radio access technologies defined in a given specification of a standard, such as the standards provided by 3GPP or ETSI, which sets out what the various entities associated with the communication system and the communication devices accessing or connecting to the communication system are permitted to do and how that should be achieved. Communication protocols and/or parameters which shall be used by communication devices for accessing or connecting to a communication system are also typically defined in standards. Examples of a standard are the so-called LTE (Long-term Evolution) and 5G (5^{th} Generation) standards provided by 3GPP.

### SUMMARY

According to one aspect, there is provided a method comprising: receiving network slice information from a core network entity, the network slice information related to a network slice which is not supported in one or more cells of a first tracking area but which is supported in one or more cells of a second tracking area; and triggering a procedure at a user equipment to access said network slice based on said network slice information when said user equipment is in one or more cells of the first tracking area.

The method may comprise determining if the procedure to access said network slice will be accepted using said network slice information and if so, triggering the procedure.

The procedure may comprise triggering a cell reselection towards one of the one or more cells of the second tracking area.

The procedure may comprise triggering a service request to activate connectivity in the network slice.

The procedure may comprise triggering a packet data unit session establishment request to request a packet data unit session of the network slice.

The procedure may comprise triggering a registration request to register with the network slice.

The network slice information may provide information for the access to the network slice by the user equipment.

The method may comprise causing a request to be sent to the core network entity and receiving the network slice information in a response to said request.

The request may comprise a registration request and the response may comprise a registration accept message.

The method may comprise receiving the network slice information in a configuration update message.

The network slice information may indicate that the one or more cells in the first tracking area overlap with at least one of the one or more cells of the second TA.

The network slice information may indicate indirect access to the network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The method may comprise receiving partially allowed information for the network slice indicating that said network slice is a partially allowed slice in a registration area and an indication where said network slice is supported.

The method may comprise receiving the partially allowed information in a register accept message or a user equipment configuration updated message.

The method may comprise receiving partially rejected information for the network slice indicating that said network slice is a partially rejected slice in a registration area and an indication where said network slice is supported.

The method may comprise receiving the partially rejected information in a register accept message or a user equipment configuration updated message.

There may be a plurality of first tracking areas and/or second tracking areas.

The core network entity may be an access and management function entity

The method may be performed by an apparatus. The apparatus may be provided in a user equipment or is a user equipment.

According to another aspect, there may be provided an apparatus comprising: means for receiving network slice information from a core network entity, the network slice information related to a network slice which is not supported in one or more cells of a first tracking area but which is supported in one or more cells of a second tracking area; and means for triggering a procedure at a user equipment to access said network slice based on said network slice information when said user equipment is in one or more cells of the first tracking area.

The apparatus may comprise means for determining if the procedure to access said network slice will be accepted using said network slice information and if so, triggering the procedure.

The procedure may comprise triggering a cell reselection towards one of the one or more cells of the second tracking area.

The procedure may comprise triggering a service request to activate connectivity in the network slice.

The procedure may comprise triggering a packet data unit session establishment request to request a packet data unit session of the network slice.

The procedure may comprise triggering a registration request to register with the network slice.

The network slice information may provide information for the access to the network slice by the user equipment.

The apparatus may comprise means for causing a request to be sent to the core network entity and receiving the network slice information in a response to said request.

The request may comprise a registration request and the response may comprise a registration accept message.

The means for receiving may be for receiving the network slice information in a configuration update message.

The network slice information may indicate that the one or more cells in the first tracking area overlap with at least one of the one or more cells of the second TA.

The network slice information may indicate indirect access to the network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The means for receiving may be for receiving partially allowed information for the network slice indicating that said network slice is a partially allowed slice in a registration area and an indication where said network slice is supported.

The means for receiving may be for receiving the partially allowed information in a register accept message or a user equipment configuration updated message.

The means for receiving may be for receiving partially rejected information for the network slice indicating that said network slice is a partially rejected slice in a registration area and an indication where said network slice is supported.

The means for receiving may be for receiving the partially rejected information in a register accept message or a user equipment configuration updated message.

There may be a plurality of first tracking areas and/or second tracking areas.

The core network entity may be an access and management function entity

The apparatus may be provided in a user equipment or is a user equipment.

According to another aspect, there is provided an apparatus comprising circuitry configured to: receive network slice information from a core network entity, the network slice information related to a network slice which is not supported in one or more cells of a first tracking area but which is supported in one or more cells of a second tracking area; and trigger a procedure at a user equipment to access said network slice based on said network slice information when said user equipment is in one or more cells of the first tracking area.

The circuitry may be configured to determine if the procedure to access said network slice will be accepted using said network slice information and if so, triggering the procedure.

The procedure may comprise triggering a cell reselection towards one of the one or more cells of the second tracking area.

The procedure may comprise triggering a service request to activate connectivity in the network slice.

The procedure may comprise triggering a packet data unit session establishment request to request a packet data unit session of the network slice.

The procedure may comprise triggering a registration request to register with the network slice.

The network slice information may provide information for the access to the network slice by the user equipment.

The circuitry may be configured to cause a request to be sent to the core network entity and receiving the network slice information in a response to said request.

The request may comprise a registration request and the response may comprise a registration accept message.

The circuitry may be configured to receive the network slice information in a configuration update message.

The network slice information may indicate that the one or more cells in the first tracking area overlap with at least one of the one or more cells of the second TA.

The network slice information may indicate indirect access to the network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The circuitry may be configured to receive partially allowed information for the network slice indicating that said network slice is a partially allowed slice in a registration area and an indication where said network slice is supported.

The circuitry may be configured to receive the partially allowed information in a register accept message or a user equipment configuration updated message.

The circuitry may be configured to receive partially rejected information for the network slice indicating that said network slice is a partially rejected slice in a registration area and an indication where said network slice is supported.

The circuitry may be configured to receive the partially rejected information in a register accept message or a user equipment configuration updated message.

There may be a plurality of first tracking areas and/or second tracking areas.

The core network entity may be an access and management function entity

The apparatus may be provided in a user equipment or is a user equipment.

According to another aspect, there is provided an apparatus comprising at least one processor and at least one memory storing instructions that, when executed by the at least one processor cause the apparatus at least to: receive network slice information from a core network entity, the network slice information related to a network slice which is not supported in one or more cells of a first tracking area but which is supported in one or more cells of a second tracking area; and trigger a procedure at a user equipment to access said network slice based on said network slice information when said user equipment is in one or more cells of the first tracking area.

The apparatus may be caused to determine if the procedure to access said network slice will be accepted using said network slice information and if so, triggering the procedure.

The procedure may comprise triggering a cell reselection towards one of the one or more cells of the second tracking area.

The procedure may comprise triggering a service request to activate connectivity in the network slice.

The procedure may comprise triggering a packet data unit session establishment request to request a packet data unit session of the network slice.

The procedure may comprise triggering a registration request to register with the network slice.

The network slice information may provide information for the access to the network slice by the user equipment.

The apparatus may be caused to cause a request to be sent to the core network entity and receiving the network slice information in a response to said request.

The request may comprise a registration request and the response may comprise a registration accept message.

The apparatus may be caused to receive the network slice information in a configuration update message.

The network slice information may indicate that the one or more cells in the first tracking area overlap with at least one of the one or more cells of the second TA.

The network slice information may indicate indirect access to the network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The apparatus may be caused to receive partially allowed information for the network slice indicating that said network slice is a partially allowed slice in a registration area and an indication where said network slice is supported.

The apparatus may be caused to receive the partially allowed information in a register accept message or a user equipment configuration updated message.

The apparatus may be caused to receive partially rejected information for the network slice indicating that said network slice is a partially rejected slice in a registration area and an indication where said network slice is supported.

The apparatus may be caused to receive the partially rejected information in a register accept message or a user equipment configuration updated message.

There may be a plurality of first tracking areas and/or second tracking areas.

The core network entity may be an access and management function entity

The apparatus may be provided in a user equipment or is a user equipment.

According to another aspect, there is provided a method comprising: receiving network slice information at a core network entity from a radio access node, the network slice information related to a network slice which is not supported in one or more cells of a first tracking area but which is supported in one or more cells of a second tracking area; and causing a message to be sent to the user equipment when the user equipment is in one or more cells of the first tracking area, the message comprising the network slice information.

The message may comprise a user equipment configuration update message.

The method may comprise receiving a request originating from a user equipment for said network slice when the user equipment is in one or more cells of the first tracking area

The request originating from the user equipment may be a registration request.

The method may comprise causing a response to be provided to user equipment in response to the request.

The message may be provided by said response.

The network slice information may be received in a radio access network set up request.

The network slice information may be received in radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

According to another aspect, there is provided an apparatus comprising: means for receiving network slice information at a core network entity from a radio access node, the network slice information related to a network slice which is not supported in one or more cells of a first tracking area but which is supported in one or more cells of a second tracking area; and means for causing a message to be sent to the user equipment when the user equipment is in one or more cells of the first tracking area, the message comprising the network slice information.

The message may comprise a user equipment configuration update message.

The apparatus may comprise means for receiving a request originating from a user equipment for said network slice when the user equipment is in one or more cells of the first tracking area

The request originating from the user equipment may be a registration request.

The method may comprise causing a response to be provided to user equipment in response to the request.

The message may be provided by said response.

The network slice information may be received in a radio access network set up request.

The network slice information may be received in radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The apparatus may comprise means for causing partially allowed information for the network slice to be provided to the user equipment, the partially allowed information indicating that said network slice is a partially allowed slice in a registration area of the user equipment and an indication where said network slice is supported.

The message may comprise the partially allowed information.

The apparatus may comprise means for causing partially rejected information for the network slice to be provided to the user equipment, the partially rejected information indicating that said network slice is a partially rejected slice in a registration area of the user equipment and an indication where said network slice is supported.

The message may comprise the partially rejected information

There may be a plurality of first tracking areas and/or second tracking areas.

The core network entity is an access and management function entity.

The apparatus may be in or provided by the core network function.

According to another aspect, there is provided an apparatus comprising circuitry configured to: receive network slice information at a core network entity from a radio access node, the network slice information related to a network slice which is not supported in one or more cells of a first tracking area but which is supported in one or more cells of a second tracking area; and cause a message to be sent to the user equipment when the user equipment is in one or more cells of the first tracking area, the message comprising the network slice information.

The message may comprise a user equipment configuration update message.

The circuitry may be configured to receive a request originating from a user equipment for said network slice when the user equipment is in one or more cells of the first tracking area

The request originating from the user equipment may be a registration request.

The circuitry may be configured to cause a response to be provided to user equipment in response to the request.

The message may be provided by said response.

The network slice information may be received in a radio access network set up request.

The network slice information may be received in radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The circuitry may be configured to cause partially allowed information for the network slice to be provided to the user equipment, the partially allowed information indicating that said network slice is a partially allowed slice in a registration area of the user equipment and an indication where said network slice is supported.

The message may comprise the partially allowed information.

The circuitry may be configured to cause partially rejected information for the network slice to be provided to the user equipment, the partially rejected information indicating that said network slice is a partially rejected slice in a registration area of the user equipment and an indication where said network slice is supported.

The message may comprise the partially rejected information

There may be a plurality of first tracking areas and/or second tracking areas.

The core network entity is an access and management function entity.

The apparatus may be in or provided by the core network function.

According to another aspect, there is provided an apparatus comprising at least one processor and at least one memory storing instructions that, when executed by the at least one processor cause the apparatus at least to: receive network slice information at a core network entity from a radio access node, the network slice information related to a network slice which is not supported in one or more cells of a first tracking area but which is supported in one or more cells of a second tracking area; and cause a message to be sent to the user equipment when the user equipment is in one or more cells of the first tracking area, the message comprising the network slice information.

The message may comprise a user equipment configuration update message.

The apparatus may be caused to receive a request originating from a user equipment for said network slice when the user equipment is in one or more cells of the first tracking area

The request originating from the user equipment may be a registration request.

The apparatus may be caused to cause a response to be provided to user equipment in response to the request.

The message may be provided by said response.

The network slice information may be received in a radio access network set up request.

The network slice information may be received in radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

The apparatus may be caused to cause partially allowed information for the network slice to be provided to the user equipment, the partially allowed information indicating that said network slice is a partially allowed slice in a registration area of the user equipment and an indication where said network slice is supported.

The message may comprise the partially allowed information.

The apparatus may be caused to cause partially rejected information for the network slice to be provided to the user equipment, the partially rejected information indicating that said network slice is a partially rejected slice in a registration area of the user equipment and an indication where said network slice is supported.

The message may comprise the partially rejected information

There may be a plurality of first tracking areas and/or second tracking areas.

The core network entity is an access and management function entity.

The apparatus may be in or provided by the core network function.

According to another aspect, there may be provided a method comprising: providing network slice information to a core network entity by a radio access node, the network slice information related to a network slice which is not supported in one or more cells of a first tracking area, but which is supported in one or more cells of a second tracking area.

The network slice information may be provided in a radio access network set up request.

The network slice information may be provided in a radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

There may be a plurality of first tracking areas and/or second tracking areas.

The core network entity is an access and management function entity.

The method may be performed by an apparatus. The apparatus may be in or provided by the radio access node.

According to another aspect, there may be provided an apparatus comprising: means providing network slice information to a core network entity by a radio access node, the network slice information related to a network slice which is not supported in one or more cells of a first tracking area, but which is supported in one or more cells of a second tracking area.

The network slice information may be provided in a radio access network set up request.

The network slice information may be provided in a radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

There may be a plurality of first tracking areas and/or second tracking areas.

The core network entity is an access and management function entity.

The apparatus may be in or provided by the radio access node.

According to another aspect, there may be provided an apparatus comprising circuitry configured to: provide network slice information to a core network entity by a radio access node, the network slice information related to a network slice which is not supported in one or more cells of a first tracking area, but which is supported in one or more cells of a second tracking area.

The network slice information may be provided in a radio access network set up request.

The network slice information may be provided in a radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

There may be a plurality of first tracking areas and/or second tracking areas.

The core network entity is an access and management function entity.

The apparatus may be in or provided by the radio access node.

According to another aspect, there is provided an apparatus comprising at least one processor and at least one memory storing instructions that, when executed by the at least one processor cause the apparatus at least to: provide network slice information to a core network entity by a radio access node, the network slice information related to a network slice which is not supported in one or more cells of a first tracking area but which is supported in one or more cells of a second tracking area.

The network slice information may be provided in a radio access network set up request.

The network slice information may be provided in a radio access configuration update.

The network slice information may provide information for the access to the network slice by the user equipment.

The network slice information may provide information that the one or more cells in the first tracking area overlap with at least one of the one or more cells of the second tracking area.

The network slice information may indicate indirect access to the said network slice when the user equipment is located in the one or more cells of the first tracking area.

The indirect access may comprise at least one of: redirection to one or more cells of the second tracking area; handover to one or more cells of the second tracking area; and/or dual connectivity with one or more cells of the second tracking area.

The network slice information may indicate indirect access to the said network slice access group of the network slice.

The one or more cells of the first and/or second tracking areas may be identified by a respective cell identifier.

The one or more cells of the first and/or second tracking areas may be identified by an indication of the respective tracking area identity.

The one or more cells of the first and/or second tracking areas may be identified by an indication of a respective cell group identifier.

There may be a plurality of first tracking areas and/or second tracking areas.

The core network entity is an access and management function entity.

The apparatus may be in or provided by the radio access node.

According to a further aspect, there is provided a computer program comprising instructions, which when executed by an apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by the apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described, by way of example only, with reference to the accompanying Figures in which:

FIG. 1 shows a schematic representation of a 5G system;

FIG. 2 shows a schematic representation of an apparatus;

FIG. 3 shows a schematic representation of a user equipment;

FIG. 4 shows an example of tracking areas in a registration area of a UE:

FIG. 5 shows a first example of a signalling flow of some embodiments;

FIG. 6 shows a second example of a signalling flow of some embodiments;

FIG. 7 shows a third example of a signalling flow of some embodiments;

FIG. 8 shows a fourth example of a signalling flow of some embodiments;

FIG. 9 shows an example of a signalling flow which may be used in conjunction with any of the signalling flows of FIGS. 5 to 8;

FIG. 10 show a first method of some embodiments;

FIG. 11 show a second method of some embodiments;

FIG. 12 show a third method of some embodiments; and

FIG. 13 shows a schematic representation of a non-volatile memory medium storing instructions which when executed by a processor allow a processor to perform one or more of the steps of any of the methods of FIGS. 10 to 12.

### DETAILED DESCRIPTION

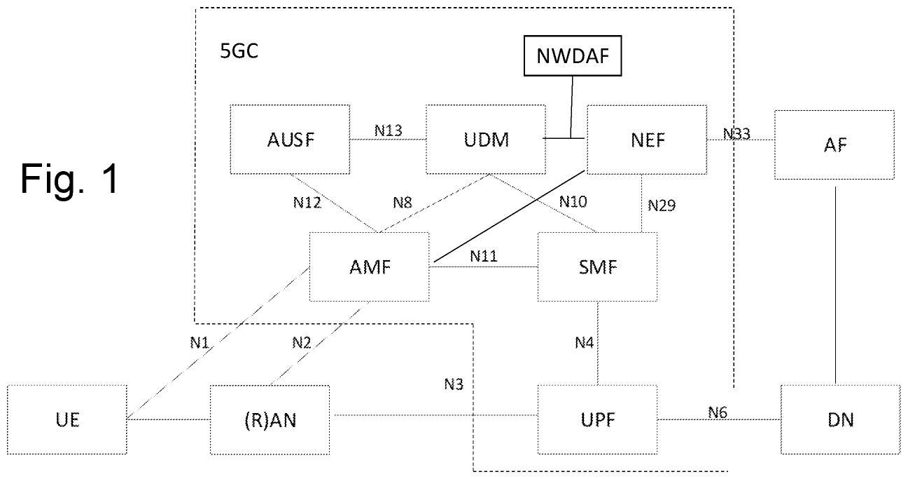

In the following certain embodiments are explained with reference to communication devices capable of communication via a wireless cellular system and mobile communication systems serving such communication devices. Before explaining in detail the exemplifying embodiments, certain general principles of a wireless communication system, access systems thereof, and communication devices are briefly explained with reference to FIGS. 1, 2 and 3 to assist in understanding the technology underlying the described examples.

FIG. 1 shows a schematic representation of a communication system operating based on a 5^{th} generation radio access technology (generally referred to as a 5G system (5GS)). The 5GS may a (radio) access network ((R)AN), a 5G core network (5GC), one or more application functions (AF) and one or more data networks (DN). A user equipment may access or connect to the one or more DNs via the 5GS.

The 5G (R)AN may comprise one or more base stations or radio access network (RAN) nodes, such as a gNodeB (gNB). A base station or RAN node may comprise one or more distributed units connected to a central unit.

The 5GC may comprise various network functions, such as an access and mobility management function (AMF), a session management function (SMF), an authentication server function (AUSF), a user data management (UDM), a user plane function (UPF) a network data analytics function (NWDAF) and/or a network exposure function (NEF). The operations performed by each of the various network functions of the 5G are described in 3GPP TS 23.501 and TS 23.502 version 16.

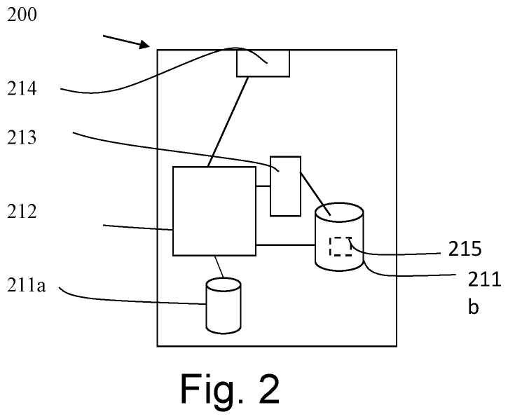

FIG. 2 illustrates an example of an apparatus 200. The apparatus 200 may be provided in the 5GS. The apparatus 200 may have at least one processor and at least one memory storing instructions of one or more of the network functions of the 5GS that, when executed by the at least one processor cause one or more functions to be performed. In this example, the apparatus may comprise at least one random access memory (RAM) 211a, and/or at least one read only memory (ROM) 211b, and/or at least one processor 212, 213 and/or an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects.

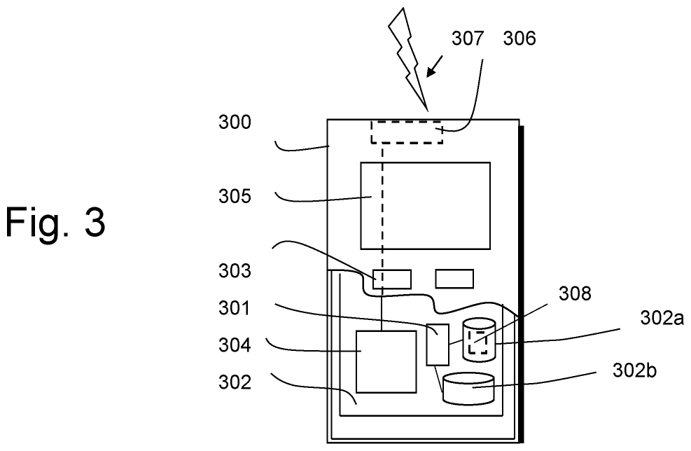

FIG. 3 illustrates an example of a communications device 300. The communications device 300 may be any device capable of sending and receiving radio signals. Non-limiting examples of a communication device 300 comprise a user equipment, such as the user equipment shown illustrated in FIG. 1, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The communications device 300 may send or receive, for example, radio signals carrying communications. The communications may be one or more of voice, electronic mail (email), text message, multimedia, data, machine data and so on.

The communications device 300 may receive radio signals over an air or radio interface 307 via appropriate apparatus for receiving and may transmit radio signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device and may include a single antenna or multiple antennas. The antenna arrangement may be an antenna array comprising a plurality of antenna elements.

The communications device 300 may be provided with at least one processor 301, and/or at least one ROM 302a, and/or at least one RAM 302b and/or other possible components 303 for use in software and hardware aided execution of tasks it is designed to perform, including control of access to and communications with access systems, such as the 5G RAN and other communication devices. The at least one processor 301 is coupled to the RAM 302b and the ROM 302a. The at least one processor 301 may be configured to execute instructions of software code 308. Execution of the instructions of the software code 308 may for example allow to the communication device 300 perform one or more operations. The software code 308 may be stored in the ROM 302a. It should be appreciated that in other embodiments, any other suitable memory may be alternatively or additionally used with the ROM and/or RAM examples set out above.

The at least one processor 301, the at least one ROM 302a, and/or the at least one RAM 302b can be provided on an appropriate circuit board, in an integrated circuit, and/or in chipsets. This feature is denoted by reference 304.

The communications device 300 may optionally have a user interface such as keypad 305, touch sensitive screen or pad, combinations thereof or the like. Optionally, the communication device may have one or more of a display, a speaker and a microphone.

In the following examples, the term UE or user equipment is used. This term encompasses any of the example of communication device 300 previously discussed and/or any other communication device.

An example of wireless communication systems are architectures standardized by the 3rd Generation Partnership Project (3GPP). The currently radio access technology being standardized by 3GPP is often referred to as 5G or NR. Other radio access technologies standardized by 3GPP include long term evolution (LTE) or LTE Advanced Pro of the Universal Mobile Telecommunications System (UMTS). Wireless communication systems generally include access networks, such as radio access networks operating based on a radio access technology that include base stations or a radio access network nodes. Wireless communication systems may also include other types of access networks, such as a wireless local area network (WLAN) and/or a WiMAX (Worldwide Interoperability for Microwave Access) network. It should be understood that example embodiments may also be used with standards for future radio access technologies such as 6G and beyond.

Network Slices are logical entities which are split on the resource level to provide an end-to-end service. The resource may be computing resource, storage resource, bandwidth in the transport network and radio resource. The resources may be assigned in a dedicated or shared manner Each network slice connects to different network function optimizations. Network slices may be set up either to serve different sets of use cases or to serve the same service but for different set of UEs. For example, a 5GS may have a first network slice between the UE and a UPF providing a first service, such as enhanced mobile broadband (eMBB) and a second network slice between the UE and a different UPF providing a second service, such as ultra-reliable low latency communications (URLLC).

5GS enables a user equipment to access to one or more applications. When, a user equipment requests a service)\, the network maps the service to a network slice fulfilling a SLA (service level agreement). The user service is mapped to a corresponding slice and this mapping is part of URSP (UE Route Selection Policy) rules in a UE.

Network slicing allows a 5GS to support of different services using the same underlying network infrastructure. Network slices can differ either in their service requirements or the tenant providing those services such as e.g., Ultra-Reliable Low Latency Communication (URLLC) and enhanced Mobile Broadband (eMBB).

A network slice is uniquely identified by the S-NSSAI (Single Network Slice Selection Assistance Information). 3GPP specifications (e.g., 3GPP TS 23.501) allow a UE to be simultaneously connected to and served by at most eight network slices identified by S-NSSAIs and each cell of a TA may support tens or even hundreds of network slices identified by S-NSSAIs such that, for example, a tracking area can support up to 65535 network slices. However, these numbers can vary depending on the standard, for example.

A registration area (RA) in a 5GS is a list consisting of tracking areas (TAs) which is configured to the UE by the core network. The UE receives the RA and TA information from the gNB.

The registration area is used to maintain allowed network slices (identified by an allowed NSSAI) for the UE. The allowed network slices (S-NSSAIs) are or the allowed NS SAI may be configured to the UE by the network. An allowed S-NSSAI can refer to an S-NSSAI included in the allowed NSSAI. The UE can request registration to a network sliced identified by a S-NSSAI by sending a registration request to register with the network slice and the network would decide whether or not to add that S-NSSAI to the UE's list of allowed S-NSSAIs or the UE's allowed NSSAI.

3GPP TS 23.501 version 17 for 5G requires all network slices identified by a S-NSSAI (single network slice selection assistance information) contained in an allowed NSSAI to be supported in all TAs (tracking areas) of the RA (registration area) of the UE.

3GPP TS 23.501 version 18 for 5G introduces the possibility to indicate a “partially allowed NSSAI”. The partially allowed NSSAI contains S-NSSAIs identifying network slices which are supported only in one or more TAs of the RA of the UE which therefore constitute a subset of the RA. In other words, the partially allowed NS SAI identifies network slices which are not supported by all the TAs of the RA of the UE. Thus, a registration area may comprise tracking areas supporting different network slices such that a tracking area in the registration area of a UE may support additional network slices in addition to all allowed network slices of the UE.

With partially allowed NSSAI, one option is that the UE is allowed to send a mobile originated (MO) request for a partially allowed network slice including a partially supported network slice when camping in a cell of the subset of TAs supporting that network slice. The UE can send a MO request without first sending a registration request to register with that network slice to the core network of a 5GS. The UE could also be enabled to send a request to access a service of a network slice (service request) when the UE is in cells not supporting the network slice, by having the network use a handover procedure to the overlapping cell, or a redirection procedure to the overlapping cell, or dual connectivity to the overlapping cell.

In practice, this might increase signalling between the UE and the core network of the 5GS. This is because as the UE is moving in the RA, the UE has no information regarding which ones of the cells or TAs is actually overlapped by a TA supporting a partially allowed network slice. Therefore, the UE will send a service request to access a service of the partially allowed network slice when moving across cells and the service request may be rejected if the UE is not in a cell overlapping a cell of the tracking area supporting the partially allowed network slice.

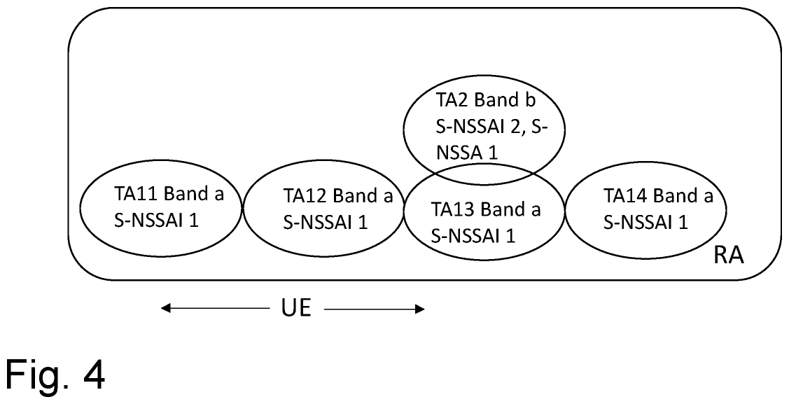

An example of an advantage of the partially allowed NSSAI is shown in FIG. 4. In FIG. 4, a RA of the UE is shown. In this example, the RA of the UE has tracking areas denoted TA11, TA12, TA13, TA14 and TA2. TA11, TA12, TA13 and TA14 serving a frequency band denoted band a. TA2 serves a frequency band denoted band b. The UE is moving in the RA of the UE. S-NSSAI 1 (identifying network slice 1) is supported in all TAs of the RA of the UE—that is all of tracking areas TA11, TA12, TA13, TA14 and TA2. S-NSSAI 2 (identifying network slice 2) is only supported in TA2.

The UE receives the following information:

Information identifying the TAs of the RA, information indicating any network slices which are supported by all of the TAs of the RA and information slices which are supported by one or more but not all of the tracking areas of the RA. For any network slices which are supported by one or more but not all of the tracking areas of the RA, information is also provided as to the tracking areas in which those network slices are supported.

For the example shown in FIG. 4, the following information may be provided to the UE.

RA=TA11, TA12, TA13, TA14, TA2

Allowed NSSAI=S-NSSAI 1

Partially Allowed S-NSSAI=S-NSSAI 2, supported in TA2

With the partially allowed NSSAI, the UE can send a service request to access network slice 2 of band b while moving within the RA if the UE re-selects a cell of TA2, without having to re-register with the core network (5GC) of the 5GS. As noted, TA2 is part of the RA.

In some embodiments, a UE will receive a message comprising information about a partially allowed NSSAI. The message may be a registration accept message or a UE configuration update message. The message comprises an indication that network slice 2 is a not supported in cells of TA1 but network slice 2 is supported in cells of TA2.

In some embodiments, the UE will also receive network slice information for network slice 2. The network slice information for network slice 2 comprises overlap information (e.g., cells of TAI1 overlapped by cells of TA2) or indirect access information (e.g., cells in TA1 provides indirect access to cells of TA2). The UE may thus receive network slice information for network slice 2 which can be used by the UE to determine if the UE can access that network slice and/or how the UE may access that network slice.

The information about the partially allowed NSSAI and the network slice information may be provided together or separately.

The network slice information may be broadcast by a base station or RAN node to a UE or may be included in a message by a network entity (e.g., the AMF) of the 5GS and sent to the UE such as a register accept message or a UE configuration update message.

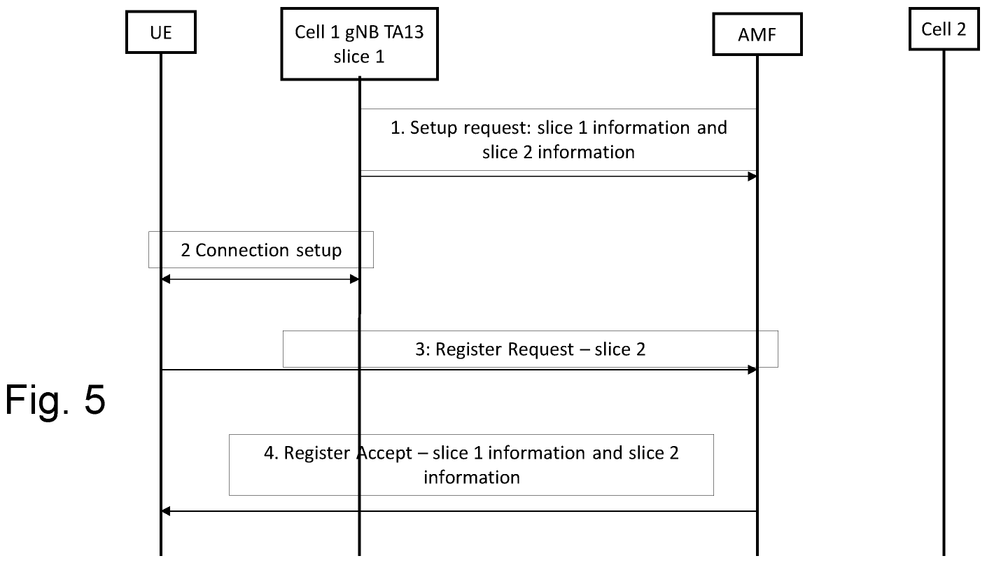

Some signal flows will now be described which show different examples of the providing of the network slice information to a UE. Reference is made to FIG. 5 which shows a first signal flow of the providing of network slice information to a UE of some embodiments.

As referenced at 1, a base station or a radio access node, denoted gNB1 in FIG. 5 in a first cell sends a setup request to an AMF of a core network of a 5GS. The setup request may be a NG setup request or any other suitable setup request. The set-up request will provide the AMF with RAN information necessary to operate the NG interface between the AMF and the RAN node. This includes slice information which the AMF requires to support later registration requests or service requests for network slices from the UE. The first cell is associated with TA13 and network slice 1 in this example. In this example, network slice 1 is allowed in all the tracking areas of the RA of the UE.

The setup request comprises information which will allow the UE to make a determination to be made as to how a network slice associated with one or more tracking areas (other than TA13 in this example) can be accessed via one or more different tracking areas. This network slice is not an allowed network slice in the one or more the tracking areas of the RA and is referred to as network slice 2 in this example. Network slice 2 is a partially allowed network slice. Network slice 2 is a not allowed network slice in TA13 in this example.

Each tracking area may be associated with one or more cells.

The setup request may include information indicating that the gNB1 supports network slice 1 in TAI13. The setup request may include information indicating that the network slice 1 is supported by the S-NSSAI identifying network slice 1.

The setup request may include information indicating that the TA13 and/or one or more cells of TA13 overlap with another tracking area. The another tracking area may be identified by an identifier of the other tracking area, generally referred to as a tracking area identifier (tracking area ID) (TA2 in this example).

The identifiers of cells (generally referred to as cell IDs of the one or more cells of TA13 which overlap with TA2 may be provided.

The cells may alternatively or additionally be identified by cell group identifiers. The cell group identifiers may be closed access group identifiers.

The cells may alternatively or additionally be identified by a network slice group identifier. In some embodiments the UE camps on a cell that was selected in association with a certain NSAG (network slice access stratum group) then from this cell, the UE may attempt to use the network slices that are partly allowed (or partially rejected) despite not supported in these cells.

Alternatively, the gNB1 may provide information identifying the TAs or information identifying the cells within TAs which are not overlapped by any other TA.

As referenced at 2, a connection is set up between the UE and gNB1. The term connection that is set up between the UE and gNB1 may be a RRC (radio resource control) connection.

As referenced at 3, the UE sends a registration request to the AMF to register with network slice 2. The registration procedure may be used by the UE to register to a PLMN (public land mobile network/SNPN (standalone non-public network) or when there is a need to provide an update on its capabilities or protocol parameters that were for example negotiated during a previous registration.

As referenced at 4, the AMF provides the UE a response to the registration request sent by the UE. The response provided to the UE may be a registration accept message sent by the AMF of the PLMN or SNPN when the AMF determines that registration of the UE is accepted.

When the UE registers to the PLMN, the UE is given its registration area (RA) comprising all the tracking areas—TA11, TA12, TA13, TA14, and TA2 in this example. The UE may be provided with the identities of the TAs when the UE is registered.

The register accept response may comprise at least some of the information which the AMF received from the gNB1, as referenced 1.

The register accept response may comprise information relating to TA13 and/or a list of cell IDs of TA13 are overlapped with TA2 and/or list of cells of TA2.

The register accept response may comprise a list of the IDs of cells of TA2 which overlap those of TA13.

The response may indicate that network slice 2 is a partially allowed slice.

The response may indicate that network slice 2 is allowed only in TA2.

Alternatively, the response may comprise the list of TAs or the list of cells within TAs which are not overlapped by any TA.

In a modification to the signal flow of FIG. 5, the network slice information may be provided to the UE in a UE configuration update. The UE configuration update is a message triggered by the AMF towards the UE which can update the allowed NSSAI/partially allowed NSSAI. It may be triggered by the AMF after the registration phase i.e., AMF first replies with register accept then AMF sends a UE configuration update to update the allowed NSSAI/partially allowed NSSAI.

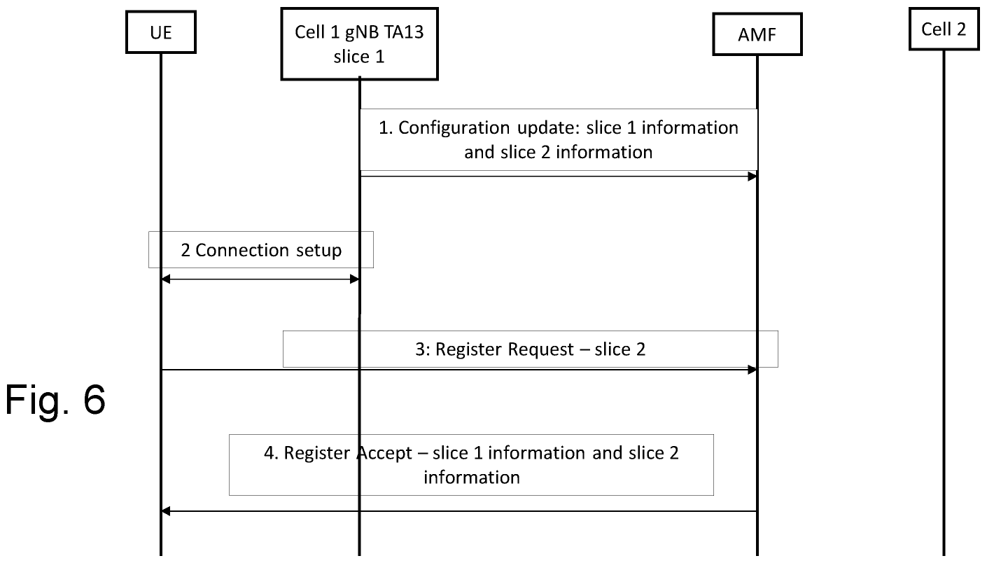

Reference is made to FIG. 6 which shows another embodiment. In this embodiment, as referenced 1, the gNB1 provides the slice 1 information and slice 2 information in a RAN configuration update message which is sent to the AMF. The information provided may be as discussed with reference to part 1 of the signal flow of FIG. 5.

Steps 2 to 4 of FIG. 6 will be as described in relation to FIG. 5.

In the signal flow of FIG. 6, the network slice information may be provided to the UE in a UE configuration update message. The UE configuration update message is a message triggered by the AMF towards the UE which can update the allowed NSSAI/partially allowed NSSAI. It may be triggered by the AMF after the registration phase i.e., AMF first replies with register accept then AMF sends a UE configuration update to update the allowed NSSAI/Partially Allowed NSSAI. In the example shown in FIG. 6, the UE sends a registration request to the AMF to register with the second network slice. In the modification to the signal flow of FIG. 6 the slice 2 would be provided in the UE configuration update message.

In one modification to the examples discussed in relation to FIGS. 5, the setup request may indicate to the AMF that TA13 is able to provide indirect access to slice 2. (This is because of the overlap of one or more cells of TA13 with one or more cells of TA2). Indirect access refers to redirection or handover or dual connectivity.

Alternatively or additionally, the setup request may provide information on the TAs and/or cells that can indirectly support the access to network slice 2.

Alternatively or additionally, the setup request may provide information about the NSAG (network slice access stratum group) which contains network slice 2. The NSAG is a group (or list) of slices (S-NSSAIs). The group may comprise one or more slices. It may be, for example, that slice 2 may be the only slice.

Alternatively or additionally, the setup request may provide information on the TAs and/or cells within TAs which cannot provide even indirect support of network slice 2 identified by S-NSSAI 2.

In one modification to the signal flow of FIG. 6, the RAN configuration update message sent by the gNB to the AMF may indicate that TA13 is able to provide indirect access to slice 2.

Alternatively or additionally, the RAN configuration update message may include information on the TAs and/or cells that can indirectly support access to network slice 2.

Alternatively or additionally, the RAN configuration update message may include information about the NSAG (network slice access stratum group) which contains slice 2.

The configuration update message sent by the gNB1 to the AMF may be a RAN configuration update message. The message may be a NGAP (next generation application protocol) RAN configuration update message.

In some embodiments, information relating the partially allowed network slice (network slice 2) may be sent to the UE via a radio broadcast. The radio broadcast may be sent by a base station or radio access node, such as a gNB of a NG-RAN.

For any cell of a tracking area e.g., TA13, not supporting the partially allowed network slice but which is at least partially overlapped by a tracking area 2 (or cells of a tracking area 2) supporting the partially allowed network slice, information is broadcast that the cell is overlapped by the tracking area 2 (or at least one cell of the tracking area 2) supporting the partially allowed network slice.

In the example of FIG. 4, any cell of TA13 which is overlapped by TA2, supporting the network slice identified by S-NSSAI 2, broadcasts information that it is overlapped by TA2.

The UE receiving this information and using the partially allowed NSSAI together with this information which indicates that TA2 supports a network slice identified by S-NSSAI 2, may determine to only trigger a procedure to access a service provided by network slice 2 when the UE determines that this request will be successful. The procedure may be UE reselecting to cell 2 of TA2 and send service request in TA2 cell 2, or the procedure may be sending a service request in current cell and be redirected to TA2 cell 2, or the procedure may be sending a PDU session setup request in the current cell and be redirected to TA2 cell 2. In some embodiment, this procedure may be followed by the network deciding to trigger in addition or in the alternative a dual connectivity between the serving gNB and the one or more cells of the TA2.

In another embodiment, or any cell of a tracking area not supporting the partially allowed network slice, but which is at least partially overlapped by a tracking area supporting the partially allowed slice, information is broadcast that it provides indirect access to the NSAG of network slice 2. Indirect access should be understood as via redirection or handover or dual connectivity.

In the example of FIG. 4, any cell of TA13 which is overlapped by TA2, supporting the network slice identified by S-NSSAI 2, broadcasts information that it provides indirect access to the NSAG of network slice 2. The information may be provided in a SIB (system information block).

The UE receiving this information and using the partially allowed NSSAI together with this information which indicates that TA2 supports a network slice identified by S-NSSAI 2, may for example re-select to the cell of TA2 to send a service request for a service provided by the network slice identified by S-NSSAI 2.

The UE receiving this information and using the partially allowed NSSAI together with this information which indicates that TA2 supports a network slice identified by S-NSSAI 2, may send the service request for a service provided by a network slice identified by S-NSSAI 2 in the current cell of TA13 (expecting the network to redirect or handover).

The UE receiving this information and using the partially allowed NSSAI together with this information which indicates that TA2 supports a network slice identified by S-NSSAI 2, may connect to cell 1 and cell 1 initiates DC (dual connectivity) with cell 2 to provide support for network slice 2. The UE will stay anchored at cell 1 but is able to offload some resources to another cell of another gNB—which in this example will be cell 2 of gNB2.

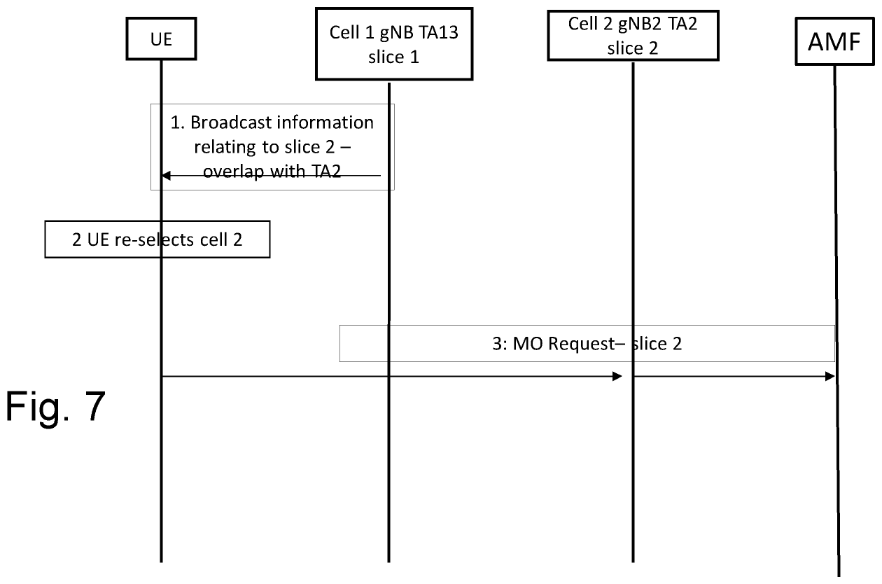

Reference is made to FIG. 7 which shows another signal flow of some embodiments. Again, this is described in the scenario where gNB1 serves cell 1 of TA13 which provides supports slice 1 (supported throughout the registration area) and slice 2 is a partially allowed slice provided in TA2.

As referenced 1, the gNB1 for cell 1 broadcasts in cell 1 information relating to slice 2. This information may be that cell 1 is overlapped with TA2 and/or at least one cell of TA2. In this example one or more TA (Tracking Area) IDs may be broadcast.

As referenced 2, the UE reselects cell 2 of TA2, based on the broadcast information. The UE uses the broadcast information, and the partially allowed S-NSSAI which indicates that TA2 supports a network slice identified by S-NSSAI 2, to determine re-selecting to the cell of TA2.

As referenced 3, the UE sends a mobile originated request to the gNB of cell 2, that is gNB2. This cell is associated with slice 2. This a service request for a service provided by the network slice identified by S-NSSAI 2. The message is forwarded by the gNB2 to the AMF.

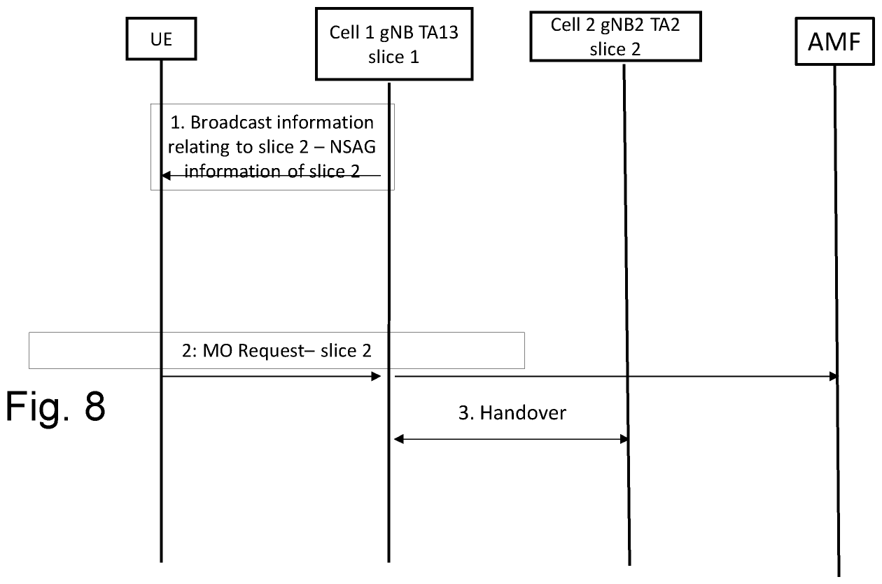

The UE will then be provided with its requested service. Reference is made to FIG. 8 which shows another signal flow of some embodiments. Again, this is described in the scenario where gNB1 serves cell 1 of TA13 which provides supports slice 1 (supported throughout the registration area) and slice 2 is a partially allowed slice provided in TA2.

As referenced 1, the gNB1 for cell 1 broadcasts in cell 1 that it provides access to the NSAG of slice 2. In this embodiment, the NSAG ID is broadcast. The NSAG is a group (or list) of slices (S-NSSAIs). NSAG ID is a short ID of 8 bits, which may be simpler for broadcast than the slice ID. Therefore, in this example, information about the NSAG containing slice 2 is broadcast. It should be appreciated that slice 2 may be the only slice contained in this NSAG.

As referenced 2, the UE sends a mobile originated request to the AMF via the gNB of cell 1. The request may be a service request or a PDU session setup request in some embodiments.

As referenced 3, the gNB1 hands over to the cell 2 of gNB2. This cell is associated with slice 2.

In some embodiments, the UE may determine whether to trigger a network slice request procedure for a partially allowed slice based on the broadcast information which it has received relating to the partially allowed slice.

If the requested partially allowed slice is not supported by a cell overlapping a current cell, the UE may refrain and/or postpone the request until there is a cell change or until the broadcast information is updated or until a timer expires.

Otherwise, the partially allowed slice can be requested.

Based on above principles, it is also possible that a cell re-selection procedure even within band a may take into account the partial slice information such as described previously. For example, a UE in a cell of TA12 may preferably reselect to a cell of TA13 than a cell of TA14 if it has the choice between these 2, with the intention to enable a possible trigger to request S-NSSAI 2 once it will be in the cell of TA13.

In some embodiments, the UE will thus use the information relating to the second network slice to make a determination if a service request for the slice will be successful and only if the UE determines that the request for the slice will be successful will the UE make a service request for the slice in the cell. This may be used in conjunction with any of the previously discussed examples.

When the UE determines from the received information that the UE will be able to access the service of the second network slice, the UE may send a registration request to the AMF to register with the second network slice. This may be used in conjunction with any of the previously discussed examples. When the UE determines from the received information that the UE will be able to access the service of the second network slice, cell reselection towards one or more cells of the second TA may carried out. Cell reselection may be provided after the UE has completed cell (re)selection (to cell 1 in the described example) and is an idle mode. The UE will perform a registration process in the reselected cell by sending a registration request to the AMF to register with the second network slice. This may be used in conjunction with any of the previously discussed examples.

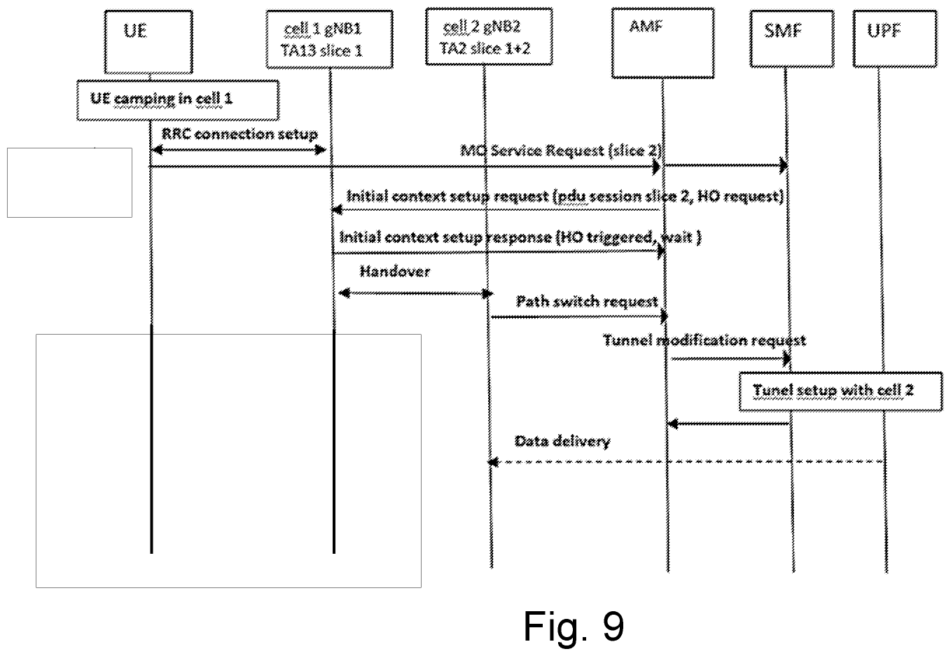

When the UE determines from the received information that the UE will be able to access the service of the second network slice, the UE may send a PDU (packet data unit) session establishment request to request a PDU session of the second network slice. This may be used in conjunction with any of the previously discussed examples. When the UE determines from the received information that the UE will be able to access the service of the second network slice, the UE may send a service request to activate connectivity in the network slice. Reference is made to FIG. 9 which shows a signal flow where a service request to access a network slice providing a service is served by an overlapping cell and is requested by a UE.

The UE is camping on cell 1.

The UE and gNB perform a RRC connection procedure.

The UE sends a mobile originating service request for the requested NSSAI, slice 2 in cell 1. In some embodiments, this request is only sent if the UE has been provided with information about the second slice, such as discussed in the previously described embodiments, and that information indicates that the service will be accepted. In other words, the service request is unlikely to be rejected. This is sent to the core network via gNB1. This service request is sent to the SMF via the AMF.

The AMF sends an initial context setup request message with a PDU session of slice 2 not supported in cell 1 to gNB1. The AMF may include a request for handover to a suitable target cell.

gNB1 triggers handover of the UE to overlapping cell 2 of gNB2 in TA 2. The gNB1 responds in an initial context setup response that handover is ongoing which makes AMF wait before contacting SMF.

The gNB1 hands the UE over to gNB2.

The gNB2 sends a path switch request to the AMF.

After receiving the path switch request from gNB2, the AMF contacts SMF to setup the tunnel between UPF and cell 2 of gNB2. The AMF sends a tunnel modification request to the SMF.

The SMF and the UPF perform a tunnel setup with respect to cell 2 of gNB2 for the UE.

The SMF will advise the AMF when the tunnel is delivered (e.g., setup).

The UPF will deliver data to gNB 2 and gNB2 will deliver the data over its cell 2. The service request for the second slice is thus successful.

It should be appreciated that this is one example of a signal flow which can be triggered when a UE wants to send a service request for a slice (slice 2) and where the UE has used the received information to determine that the service request is most likely to be accepted. The received information may be any of the examples previously discussed. The received information indicates to the UE in which cells of a current band the UE may trigger the service request without failing. That is the service request is unlikely to be rejected.

In the previously described examples, a partially allowed network slice is supported. Alternatively, in other embodiments a partially rejected network slice may be supported. For example, in the context of the FIG. 4 scenario, network slice 2 is partially rejected for the RA of the UE in that it is not supported, that is rejected, in TA 1.

For example, the AMF sends: allowed NSSAI (slice 1, slice 2), partially rejected (slice 2) and an indication where slice 2 is supported (TA2) in the case of a partially rejected slice concept.

In contrast, for the partially allowed concept the AMF, for example, sends allowed NSSAI (slice 1, slice 2), partially allowed (slice 2) and an indication where slice 2 is supported (TA2)

It should be appreciated that any of the previously described embodiments may be modified to support the partially rejected slice concept. The partially allowed slice information may be replaced the partially rejected slice information.

With the partially allowed slice concept, the UE may be able to directly trigger a service request or a PDU session setup request.

With the partially rejected slice concept, the UE may need to first register to slice 2 by sending a register request including slice 2, then can send a service request or a PDU session setup request.

With the partially rejected slice concept, the UE may need reselect to TA2 cell and send register request followed by service request to the TA2 cell.

With the partially rejected slice concept, the UE may send a register request in the current cell and be redirected to TA2 cell.

The partially rejected slice information may indicate the network slice is not supported in the one or more cells of the first TA and/or with an indication that the slice is supported in the one or more cells of the second TA.

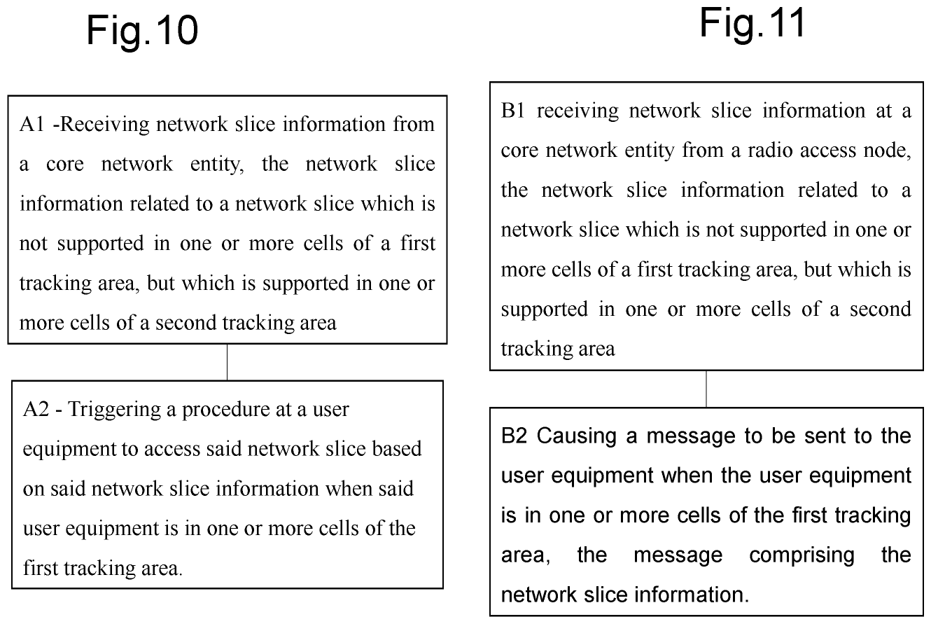

Reference is made to FIG. 10 which shows a first method of some embodiments.

This method may be performed by an apparatus. The apparatus may be in or be a user equipment.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 3.

The method may be provided by computer program code or computer executable instructions.

The method may comprise as referenced A1, receiving network slice information from a core network entity, the network slice information related to a network slice which is not supported in one or more cells of a first tracking area, but which is supported in one or more cells of a second tracking area.

The method may comprise as referenced A2, triggering a procedure at a user equipment to access said network slice based on said network slice information when said user equipment is in one or more cells of the first tracking area.

It should be appreciated that the method outlined in FIG. 10 may be modified to include any of the previously described features.

Reference is made to FIG. 11 which shows a second method of some embodiments.

This method may be performed by an apparatus. The apparatus may be in or be a core network entity. The core network entity may be an AMF.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced B1, receiving network slice information at a core network entity from a radio access node, the network slice information related to a network slice which is not supported in one or more cells of a first tracking area, but which is supported in one or more cells of a second tracking area.

The method may comprise as referenced B2, causing a message to be sent to the user equipment when the user equipment is in one or more cells of the first tracking area, the message comprising the network slice information.

It should be appreciated that the method outlined in FIG. 11 may be modified to include any of the previously described features.

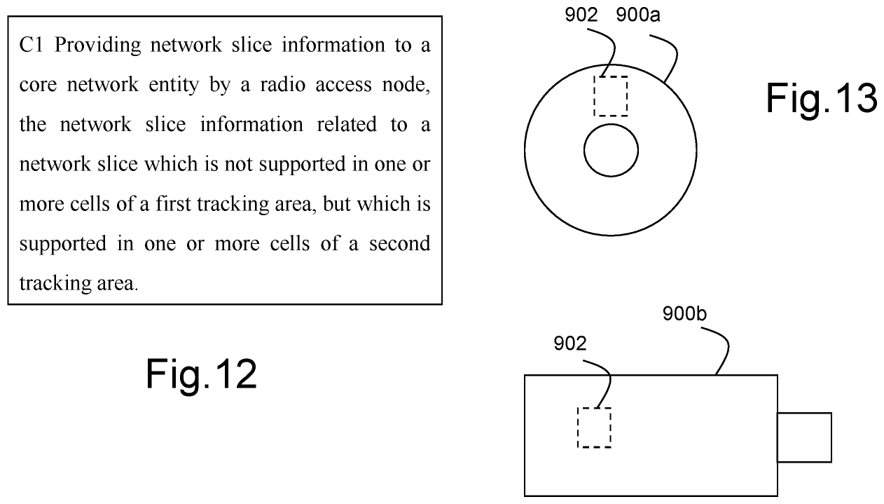

Reference is made to FIG. 12 which shows a third method of some embodiments.

This method may be performed by an apparatus. The apparatus may be in or be a radio access node. The radio access node may be a base station such as gNB.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 2.

The method may be provided by computer program code or computer executable instructions.

The method may comprise as referenced Cl, providing network slice information to a core network entity by a radio access node, the network slice information related to a network slice which is not supported in one or more cells of a first tracking area, but which is supported in one or more cells of a second tracking area.

It should be appreciated that the method outlined in FIG. 12 may be modified to include any of the previously described features.

FIG. 13 shows a schematic representation of non-volatile memory media 900a or 900b storing instructions and/or parameters which when executed by a processor allow the processor to perform one or more of the steps of the methods of any of the embodiments. The non-volatile memory media may be a computer disc (CD), or digital versatile disc (DVD) schematically referenced 900a or a universal serial bus (USB) memory stick schematically referenced 900b. The computer instructions or code may be downloaded and stored in one or more memories. The memory media may store instructions and/or parameters 902 which when executed by a processor allow the processor to perform one or more of the steps of the methods of embodiments.

Computer program code may be downloaded and stored in one or more memories of the device.

It is noted that while the above describes example embodiments, there are several variations and modifications which may be made to the disclosed solution without departing from the scope of the present invention.

It is noted that whilst some embodiments have been described in relation to 5G networks, similar principles can be applied in relation to standards.

Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of the term “means” in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the claims. The embodiments and features, if any, described in this specification that do not fall under the scope of the claims are to be interpreted as examples useful for understanding various embodiments of the disclosure.

It should be noted that different claims with differing claim scope may be pursued in related applications such as divisional or continuation applications.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

We claim:

1. A user equipment comprising:
at least one processor;
at least one memory storing instructions which, when executed by the at least one processor, cause the user equipment to perform at least:
receiving network slice information from a core network entity, the network slice information related to a network slice which is not supported in one or more cells of a first tracking area, but which is supported in one or more cells of a second tracking area; and
triggering a procedure to access said network slice based on said network slice information when said user equipment is in one or more cells of the first tracking area.

2. The user equipment as claimed in claim 1, wherein the instructions, when executed by the at least one processor, further cause the user equipment to perform at least:
based on determining that the procedure to access said network slice will be accepted using said network slice information, triggering the procedure.

3. The user equipment as claimed in claim 1, wherein the triggering a procedure comprises triggering a cell reselection towards one of the one or more cells of the second tracking area.

4. The user equipment as claimed in claim 1, wherein the triggering a procedure comprises triggering sending a service request to activate connectivity in the said network slice.

5. The user equipment as claimed in claim 1, wherein the triggering a procedure comprises triggering sending, to the core network entity, a packet data unit session establishment request to request a packet data unit session of the said network slice.

6. The user equipment as claimed in claim 1, wherein the triggering a procedure comprises triggering sending, to the core network entity, a registration request to register with the network slice.

7. The user equipment as claimed in claim 1, wherein the instructions when executed by the at least one processor, further cause the user equipment to perform:
sending a request to the core network entity and receiving the said network slice information in a response to the request.

8. The user equipment as claimed in claim 7, wherein the request comprises a registration request and the response comprises a registration accept message.

9. The user equipment as claimed in claim 1, wherein the instructions when executed by the at least one processor, further cause the user equipment to perform:
receiving the network slice information in a configuration update message.

10. The user equipment as claimed in claim 1, wherein the network slice information provides information for accessing the network slice by the user equipment and wherein the network slice information indicates that the one or more cells in the first tracking area overlap with at least one of the one or more cells of the second tracking area.

11. The user equipment as claimed in claim 1, wherein the network slice information provides information for accessing the network slice by the user equipment and wherein the said network slice information indicates indirect access to the said network slice when the user equipment is located in the one or more cells of the first tracking area.

12. The user equipment as claimed in claim 11, wherein the indirect access comprises at least one of: redirection to one or more cells of the second tracking area; handover to one or more cells of the second tracking area; or dual connectivity with one or more cells of the second tracking area.

13. The user equipment as claimed in claim 11, wherein the said network slice information indicates indirect access to the said network slice access group of the network slice.

14. The user equipment as claimed in claim 1, wherein the one or more cells of at least one of the first or second tracking areas are identified by a respective cell identifier.

15. The user equipment as claimed in claim 1, wherein the one or more cells of at least one of the first or second tracking areas are identified by: an indication of the respective tracking area identity or an indication of a respective cell group identifier.

16. The user equipment as claimed in claim 1, wherein the instructions when executed by the at least one processor further cause the user equipment to perform:
receiving partially allowed information for the network slice indicating that said network slice is a partially allowed slice in a registration area of the user equipment and an indication where said network slice is supported.

17. The user equipment as claimed in claim 16, wherein the instructions when executed by the at least one processor further cause the user equipment to perform:
receiving the partially allowed information in a register accept message or a user equipment configuration updated message.

18. The user equipment as claimed in claim 1, wherein the instructions when executed by the at least one processor further cause the user equipment to perform:
receiving partially rejected information for the network slice indicating that said network slice is a partially rejected slice in a registration area of the user equipment and an indication where said network slice is supported.

19. The user equipment as claimed claim 20, comprising receiving the partially rejected information in a register accept message or a user equipment configuration updated message.

20. A core network entity comprising:
at least one processor;
at least one memory storing instructions which, when executed by the at least on processor, cause the core network entity to perform at least:
receiving, from a radio access node, network slice information, the network slice information related to a network slice which is not supported in one or more cells of a first tracking area, but which is supported in one or more cells of a second tracking area; and
sending a message to the user equipment when the user equipment is in one or more cells of the first tracking area, the message comprising the network slice information.
